(19) United States
(12) Patent Application Publication
(10) Pub. No.: US 2025/0335929 A1
(43) Pub. Date: Oct. 30, 2025

(54) AI ENHANCED CUSTOMER SUPPORT AUTOMATION

(71) Applicant: International Business Machines Corporation, Armonk, NY (US)

(72) Inventors: Brian P. CAREY, Raleigh, NC (US); Al CHAKRA, Apex, NC (US)

(21) Appl. No.: 18/647,421

(22) Filed: Apr. 26, 2024

(51) Int. Cl. G06Q 30/016

(52) U.S. Cl. CPC G06Q 30/016

(57) ABSTRACT

Embodiments of the present disclosure provide methods, systems, and computer program products for assigning and dynamically managing a Customer Proficiency Rating for a specific customer for implementing enhanced customer support operations for a supported product or service. Disclosed embodiments provide an AI virtual support agent that receives a customer support request for a current problem, obtains a customer statement of understanding for the current problem and provides a set of questions, to obtain customer responses. In an embodiment, the AI virtual support agent evaluates the customer statement and customer responses, and calculates a customer proficiency rating for a specific customer for the support request to identify a customer skill level for the current problem. The AI virtual support agent routes customers to an optimal human support agent based on the customer proficiency rating.

### BACKGROUND

The present invention relates to digital processing systems, and more specifically, to methods, systems, and computer program products for implementing automated customer support operations to resolve customer problems.

Customer support teams need to handle a wide variety of problems and customers who request help for a supported product or service. Customers and service providers often waste time with some questions that are repetitiously asked to understand the issue and route a given customer to an available support agent that has the correct background and level of expertise needed to assist with the customer's problem. Lost time, negative customer satisfaction, and negative financial consequences typically result with current support systems. New systems and techniques are needed to enhance customer support experience for the customers of a product or service, for example by reducing the effort required for problem explanation, reducing time required for problem resolution, and improving the efficiency and effectiveness of current and future customer support interactions with a personalized customer experience.

### SUMMARY

Embodiments of the present disclosure are directed to methods, systems, and computer program products for assigning and dynamically managing a Customer Proficiency Rating for a user for implementing enhanced customer support operations for a supported product or service.

According to one embodiment of the present disclosure, a non-limiting computer implemented method is provided. The method comprises receiving a customer request for customer support for a current problem of a product or service area; where the customer request comprises identification data to identify a specific customer; obtaining a customer statement of understanding for the current problem; providing a set of questions, based on the customer statement and the current problem, to obtain customer responses; calculating, via an Artificial Intelligence (AI) virtual support agent, based on the customer statement and the customer responses, a customer proficiency rating for the customer to identify a customer skill level for the current problem; and determining, via the AI virtual support agent, based on the customer proficiency rating, to assign a support agent for the current problem.

### BRIEF DESCRIPTION OF THE DRAWINGS

FIG. 1 is a block diagram of an example computer environment for use in conjunction with one or more disclosed embodiments;

FIG. 2 is a block diagram of an example computing system for implementing a Customer Proficiency Rating for a user or customer and implementing customer support operations of one or more disclosed embodiments;

FIGS. 3A, 3B, and FIG. 3C together provide a flow chart of example operations of a method for implementing a Customer Proficiency Rating for a customer and implementing customer support operations of one or more disclosed embodiments;

FIG. 4 is a flow chart illustrating example customer assessment operations of a method for implementing a Customer Proficiency Rating of one or more disclosed embodiments;

FIGS. 5A, and 5B together provide example pseudo code of a method for implementing a Customer Proficiency Rating of one or more disclosed embodiments;

FIG. 6 is a flow chart illustrating example processing operations of a method for implementing a Customer Proficiency Rating of one or more disclosed embodiments;

FIGS. 7A, 7B, 7C, and 7D together provide example pseudo code of a method for implementing a Customer Proficiency to automatically route customer support requests to an optimal support agent of one or more disclosed embodiments; and

FIG. 8 is a flow chart of a method for implementing a Customer Proficiency Rating of a disclosed embodiment.

### DETAILED DESCRIPTION

Embodiments herein describe techniques for assessing and routing customers to a support agent for support operations for a product or service to resolve a customer's problem using computer software tools. Disclosed embodiments provide an AI virtual support agent that receives a customer support request for a current problem, obtains a customer statement of understanding for the current problem and provides a set of questions, which can reduce the time and effort required for problem explanation. In an embodiment, the AI virtual support agent identifies and provides a proposed solution for the current problem, answers customer questions, and provides documentation to the customer that is related to the proposed solution. In an embodiment, the AI virtual support agent evaluates the customer statement and customer responses, and calculates a customer proficiency rating to identify a customer skill level for the current problem for the specific customer of the support request. The AI virtual support agent routes customers to an optimal human support agent based on the customer proficiency rating. The AI virtual support agent enables effective and efficient customer support interactions to resolve customer problems and enhance the customer support experience for the customers.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

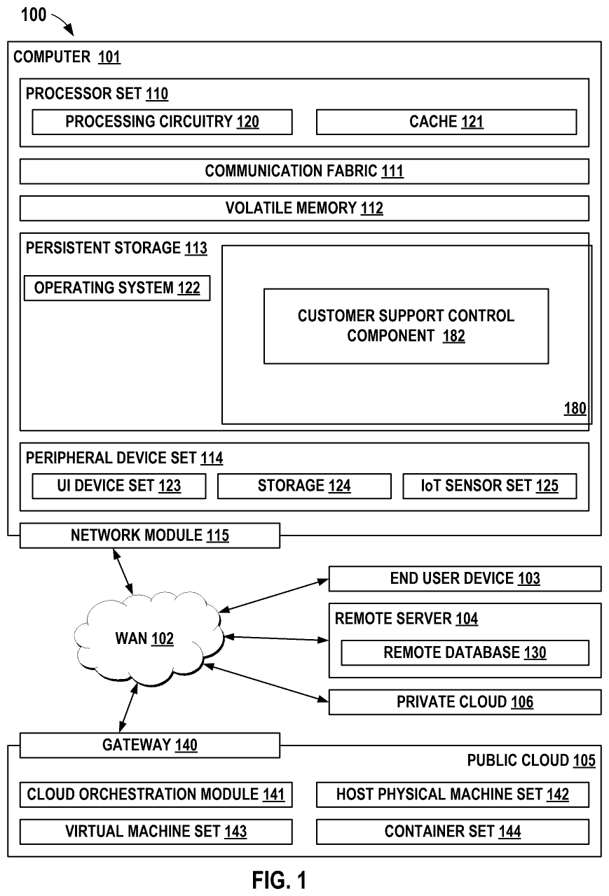

Referring to FIG. 1, a computing environment 100 contains an example of an environment for the execution of at least some of the computer code involved in performing the inventive methods, such as a Customer Support Control Component 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer- implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

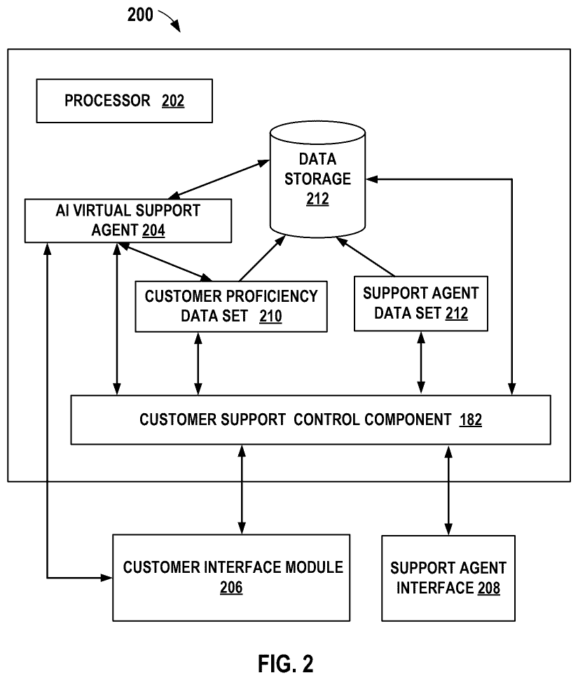

FIG. 2 illustrates an example system 200 for implementing automated assessment and routing of customer requests for resolving problems of one or more embodiments of the present disclosure. System 200 can be used in conjunction with the computer 101 and cloud environment of the computing environment 100 of FIG. 1 with the Customer Support Control Component 182 for implementing methods according to one or more embodiments.

System 200 performs enhanced methods for implementing a Customer Proficiency Rating for automated assessment and routing of customer requests for customer support interactions of disclosed embodiments. System 200 reduces time and support agents for customer support by leveraging an Artificial Intelligence (AI) virtual support agent 204 that assigns a customer proficiency rating to each specific customer for a product or service for customer support to identify a customer skill level for the current problem. System 200 can efficiently and effectively route customers to an optimal human support agent to interact with a given customer at an assessed level of understanding for the customer based on a Customer Proficiency Rating and avoid the use of highly skilled human support agents on basic problems.

System 200 includes one or more processors 202 used with the AI virtual support agent 204, which enables effectively and efficiently implementing customer support operations of disclosed embodiments. System 200 performs operations of disclosed methods (e.g., implemented with the AI virtual support agent 204 and the Customer Support Control Component 182) based on a Customer Proficiency Rating, which is calculated for the customer in accordance with disclosed embodiments.

System 200 includes a customer interface module 206 and a support agent interface module 208 (e.g., the customer interface module 206 and the support agent interface module 208 nay be separate modules as shown, or a combined single module), which enable various suitable communication implementations for use with the AI virtual support agent 204 and the Customer Support Control Component 182. For example, system 200 performs a customer assessment by the AI virtual support agent 204 and the customer interface module 206 with various forms of customer support interactions, including for example, an online chatbot, a virtual phone agent, a virtual video-conferencing agent, a virtual text messaging agent, a virtual email agent, an interactive web form, or support ticket/incident/case bot.

In a disclosed embodiment, system 200 includes a customer proficiency data set 210 storing a Customer Proficiency Rating, historical data and analytical data for each user or specific customer, and customer information for customers of system 200. In a disclosed embodiment, system 200 includes a support agent data set 212 storing information relating to support agents or subject matter experts of a customer agent support team, for example, including an expertise level, specialized skills and support problem areas of the human support agents. System 200 includes a data storage 214 that stores a database of the customer proficiency data set 210 and the support agent data set 212, which includes the Customer Proficiency Rating for each specific customer. In a disclosed embodiment, the Customer Proficiency Rating identifies a customer skill level for the current problem, and provides a baseline for each specific customer that is used by the AI virtual support agent 204 (e.g., software algorithm) to determine an optimal human support agent who can effectively communicate with the customer based on an identified competency or proficiency level of the customer. For example, the customer may speak directly with a human support agent having an appropriate level of expertise, such as a highly skilled human support agent who can explain required actions in terms the customer can easily understand. The baseline Customer Proficiency Rating advantageously is used when the customer calls for customer support in the future. Storing historical data and analytical data for each specific customer, (e.g., stored in the data storage 214) can save both the customer and the service provider time, and speed up the rate of problem resolution.

In a disclosed embodiment, system 200, the AI virtual support agent 204 is trained to perform customer support operations (e.g., using a machine learning algorithm) based on a customer support knowledge database or data storage 214 that stores the customer proficiency data set 210 and the support agent data set 212, which includes the Customer Proficiency Rating for each specific customer. The customer support knowledge database of data storage 214 stores customer support information that includes customer support correspondence or calls, which can include phone, text, video, email, chat, or other form of communication. The customer support knowledge database of data storage 214 stores information relating interactive customer support operations through customer-AI collaboration, which include a product, service or offering for the customer support, customer support questions presented to a specific customer (e.g., initial questions and additional questions based on the customer's responses), proposed solutions to a given problem, and related documentation, answers to customer questions, the time spent to route the specific customer to a human support agent, the time spent to resolve the problem, customer feedback, and the like.

The AI virtual support agent 204 is trained to perform customer support operations, for example, through natural language processing using one or more machine learning or generative artificial intelligence (AI) models, such as large language models (LLMs), based on customer data and analytical data of the customer support knowledge database of data storage 214. The AI virtual support agent 204 is trained, based on historical customer data and analytical data to identify and present questions to the customer, answer questions, provide proposed solutions, documentation, based on a given customer support request for a product, service or offering. The AI virtual support agent 204 is trained to perform customer support operation, using one or more machine learning or generative AI models to calculate a Customer Proficiency Rating and determine, based on the Customer Proficiency Rating, to assign a human support agent for the current problem. The AI virtual support agent 204 is trained to perform customer support operation, using one or more machine learning or generative AI models, to dynamically update customer data and analytical data of the customer support knowledge database of data storage 214 including Customer Proficiency Ratings.

In a disclosed embodiment, system 200, using software of the AI virtual support agent 204, calculates a current Customer Proficiency Rating for new and returning customers who contact customer support, based on their method of contact. In a disclosed embodiment, the Al virtual support agent 204 of system 200 calculates a current Customer Proficiency Rating based on customer data and analytics, such as one or more of a.) Experience with the product, including length of time (e.g., days, weeks, months, years) the customer has been using the product or service for the contact of customer support; b.) Frequency of prior support communication for current product/service; c.) Frequency of prior support communication for the current problem or issue; d.) Average Length of Time spent to solve the customer problems for this product in the past; c.) Historical average Customer Proficiency Rating (for the specific customer; and/or f.) Most recent Customer Proficiency Rating recorded for this customer.

In a disclosed embodiment, system 200, using software of the AI virtual support agent 204, uses the calculated Customer Proficiency Rating to automatically route customer support calls, emails, chats, messaging, or support cases to a human support agent to help with the specific customer. System 200 selects a human support agent using the calculated Customer Proficiency Rating, and based on the support agent data set 212. For example, in system 200, the AI virtual support agent 204 implements a software algorithm that selects a human support agent who a.) Resides in the team/area of the stated problem; and b.) Is qualified to handle the difficulty of the stated problem (e.g., one of Level 1 through Level 5); and system 200 is optimized to avoid re-routing of cases. System 200 can achieve the correct expertise level of the support agent on the first try based on current call information stated by the caller, provided in response to AI virtual support agent 204 and/or human Support Agent questions, and from historical customer Data and Analytics over time. System 200 selects a human support agent who is not over-qualified, with the system optimized to avoid assigning expert human support agents who are rated at higher levels with easy, low-level problems. This saves time and revenue since the more highly skilled agents can be available for more critical problems or projects. System 200 selects a human support agent who is at similar skill level as the customer such that they can speak on the customer's level of technical understanding. This allows the assigned human support agent to guide, explain, and walk the customer through the steps that must be performed by the customer on the customer's product, offering, service, or system to correct the issue. In the event where several agents meet the product area, expertise, and experience level needed for customer, the support agent with prior experience solving the exact problem or error of the customer request for customer support is chosen over other support agents.

In a disclosed embodiment, system 200, using software of the AI virtual support agent 204, creates a customer data file for each specific customer and logs useful data and statistics during the customer interaction with both virtual and human support agents. In an embodiment, the data stored in the customer data file includes one or more of product, service, or offering history, such as a length of time the customer has been using product, service, or offering of the customer request for customer support. In an embodiment, the data stored in the customer data file includes support contact history, such as a number of times the customer has contacted support for the current product or problem; a number of times the customer has contacted support for any product or problem; and/or the time and effort required to solve the customer's past issues. For example, the time and effort required can be based on an average duration of customer voice calls, video calls, online chats, and the like; an average length or complexity of questions in emails, texts, case messages; and a number of times the customer called, video/audio conferenced, chatted, texted, or emailed for each specific issue.

In an embodiment, the stored data store of a given customer data file includes one or more of a level of support needed of a human support agent, or an AI virtual support agent, to solve the customer's last problem; an agent team or product area that solved the customer's problems a majority of the time; and/or specific human support agents who have successfully communicated with and solved problems/cases for this customer in the past (e.g., Ann 90%, Jim 10%). In an embodiment, the stored data store of a given customer data file includes one or more of a Customer Proficiency Rating assigned by the AI virtual support agent 204 during an initial call; a Customer Proficiency Rating assigned by the AI virtual support agent 204 during the last call, a Customer Proficiency Rating assigned by the AI virtual support agent 204 during the current call, a historical average Customer Proficiency Rating for this customer; and/or a most recently recorded Customer Proficiency Rating for this customer, (e.g., the term “call” refers to any correspondence or interaction including phone, text, video, email, chat, or other form of communication).

In a disclosed embodiment, system 200 leverages historical data and analytics for the current customer as a baseline with additional factors to determine Customer Proficiency Rating that is used ultimately to route calls to a human support agent. The following table 1 provides example historical data and analytical data for the current customer.

TABLE 1

| | |
|---|---|
| a) | Percentage of calls created for prior/similar issues. |
| b) | Percentage of calls determined to be User Error for prior/similar issues. |
| c) | Percentage of calls determined to be Product Defects for prior/similar issues. |
| d) | Volume/Frequency of calls for prior/similar issues. |
| e) | Volume/Frequency of calls resulting in User Error for prior/similar issue. |
| f) | Volume/Frequency of calls resulting in Product Defect for prior/similar issues. |
| g) | Total Amount of call assets generated for prior/similar problem |
| | (Example: total number of emails/chats available or total size of call logs in |
| | the database) |
| h) | Average Customer Proficiency Rating required to solve prior/similar issues. |
| i) | Average Level of Support expertise required to solve prior/similar issues. |
| j) | Percent of prior calls resolved at each Level of Support for any issue/error |
| | (Example: Percent of all prior calls for current customer data file for any |
| | issues/errors that were resolved by each Level of Support): |
| | Level 1: 0% |
| | Level 2: 0% |
| | Level 3: 25% |
| | Level 4: 60% |
| | Level 5: 15% |
| k) | Percentage of prior calls going to specific Level of Support for prior/similar |
| | problem |
| | (Example: Percent of all prior calls for current customer data file involving |
| | “Buffer Full” errors that were resolved by each Level of Support): |
| | Level 1: 0% |
| | Level 2: 0% |
| | Level 3: 4% |
| | Level 4: 93% |
| | Level 5: 3% |

For example, in item k) of Table 1, the example statistic of prior calls involving “Buffer Full” solved by each Level of Support shows that a human support agent in Level 4 (e.g., Level 4 represents a highest weight) was able to help this specific customer with “Buffer Full” issues 93% of the time. The example statistic provides one example of multiple data analytics that are factored into a software algorithm of the AI virtual support agent 204 to determine a Level of Support expertise of a human support agent to route the call for this customer based on the customer's specific history with a “Buffer Full” problem. Future calls may require a lower level of expertise for this issue and this customer, the data logged in the customer data file will be adjusted based on a given Level of a human support agent ultimately used to solve the issue.

In a disclosed embodiment, system 200 leverages historical data and analytical data for the other customers of the product or service as a baseline with additional factors to determine Customer Proficiency Rating that is used to route calls to a human support agent. The following table 2 provides example historical data and analytical data for the other customers.

TABLE 2

| | |
|---|---|
| a) | Percentage of calls created for current/similar issues. |
| b) | Percentage of calls determined to be User Error for current/similar issue. |
| c) | Percentage of calls determined to be Product Defect for current/similar issue. |
| d) | Volume/Frequency of calls for current/similar issues. |
| e) | Volume/Frequency of calls resulting in User Error for current/similar issue. |
| f) | Volume/Frequency of calls resulting in Product Defect for current/similar |
| | issues. |
| g) | Total Amount of call assets generated for current/similar problem |
| | (Example: total number of emails/chats available or total size of call logs in the |
| | database) |
| h) | Average Customer Proficiency Rating required to solve issues for all prior |
| | customers. |
| i) | Average Level of Support expertise required to solve issues for all prior |
| | customers. |
| j) | Percent of prior calls that got resolved at each Level of Support for any |
| | issue/error. |
| | (Example: percent of all prior calls for the other customer data files for any |
| | issues/errors that were resolved by each Level of Support): |
| | Level 1: 10% |
| | Level 2: 25% |
| | Level 3: 35% |
| | Level 4: 20% |
| | Level 5: 10% |
| k) | Percentage of prior calls going to specific Level of Support for current/similar |
| | problem |
| | (Example: percent of all prior calls for the other customer data files involving |
| | “Buffer Full” errors that were resolved by each Level of Support): |
| | Level 1: 0% |
| | Level 2: 0% |
| | Level 3: 5% |
| | Level 4: 30% |
| | Level 5: 65% |

In the above example of Table 2, when the percentage of the other customer calls for the current or similar problem are typically resolved by a specific level of Support expertise, this is more heavily weighted by a software algorithm of the AI virtual support agent 204 in deciding which Level of Support expertise of the human support agent to route the call. In the above example, historically Level 5 Support was able to solve the “Buffer Full” issue 65% of the time for all other customers. Therefore, this metric will be factored into the program's decision process of which Human Support Agent and Level of Support expertise is most appropriate to route subsequent “Buffer Full” calls, while factoring in the other metrics specific to the individual specific customer.

In a disclosed embodiment, system 200 provides the ability to dynamically incorporate additional data and metrics when useful. For example, system 200 enables scalability of historical data, metrics, and analytical data, for example based on machine learning and feedback from customers, human support agents, and additional attributes inputted in system 200 would become dynamic.

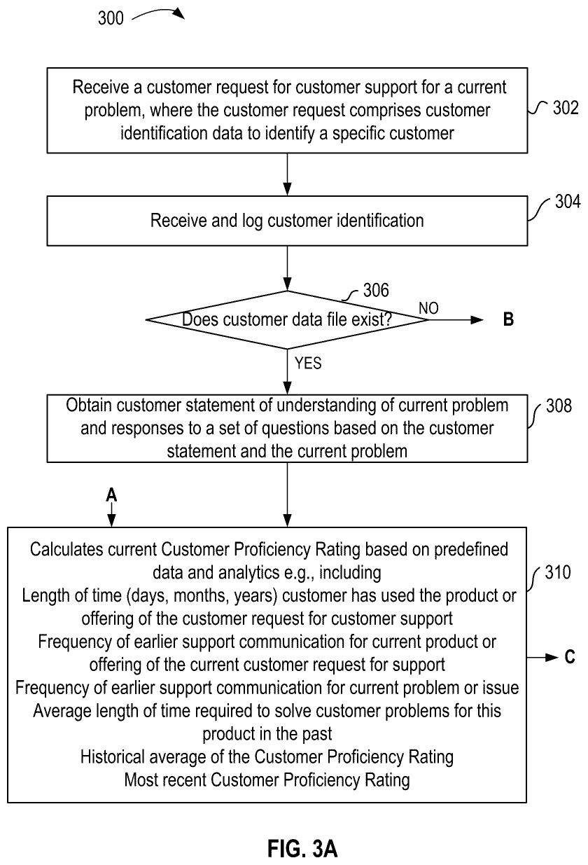

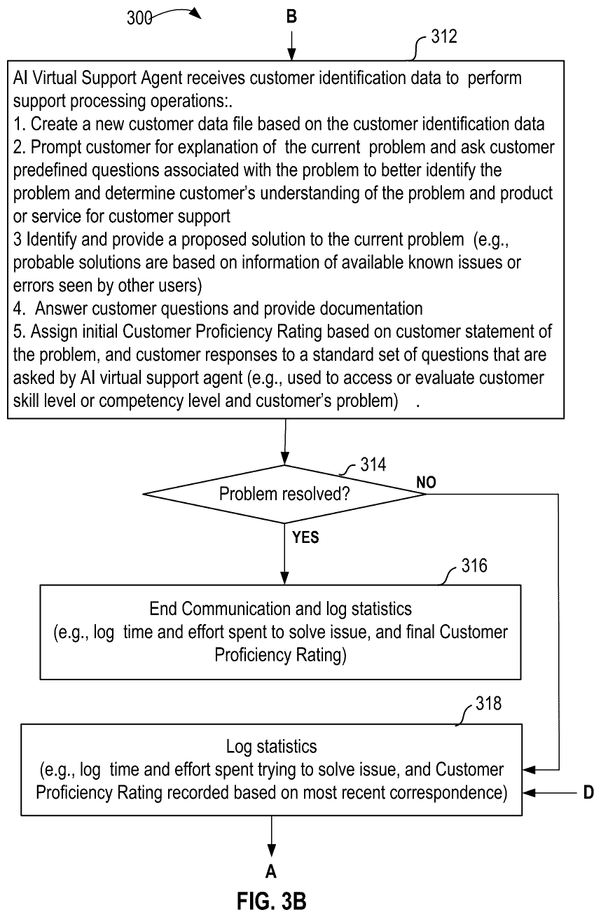

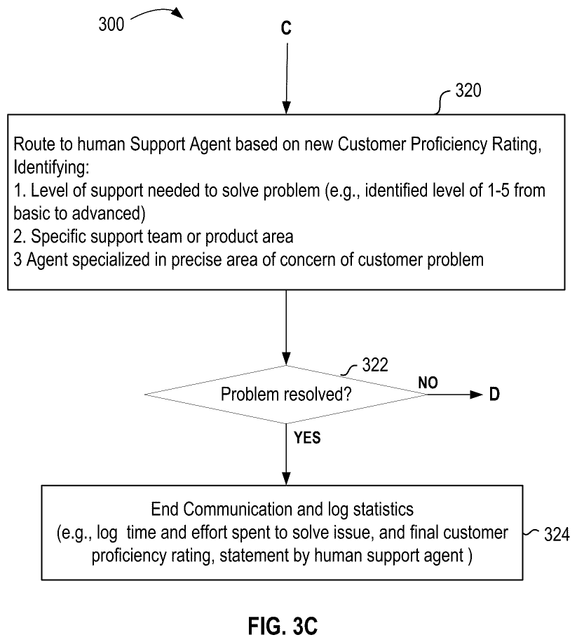

FIGS. 3A, 3B, and FIG. 3C together illustrate example operations of a method 300 for implementing a Customer Proficiency Rating for a user and customer support operations of one or more disclosed embodiments. For example, in a disclosed embodiment, method 300 is implemented by system 200 in conjunction with the computer 101 of FIG. 1 and the Customer Support Control Component 182 for implementing methods according to one or more embodiments.

In FIGS. 3A, 3B, 4, 5A, 5B, 6, 7A, 7B, 7C, 7D, and 8 the same reference numbers are used for identical or similar components as used in FIG. 2. In disclosed embodiments, respective methods 400, 500, 600, 700, and 800 are implemented by system 200 (e.g., implemented using the AI virtual support agent 204) in conjunction with the computer 101 of FIG. 1 and the Customer Support Control Component 182. Disclosed embodiments support multiple different communication technologies for interactive exchange of information.

In FIG. 3A, at block 302, system 200 receives a customer request for a current problem, where the customer request includes personal identification data to identify a specific customer. In an embodiment, the AI virtual support agent 204 with the customer interface module 206 supports various forms of customer communication interactions, including for example, an online chatbot, an interactive web form, a virtual phone agent, a virtual video-conferencing agent, a virtual text messaging agent, a virtual email agent, or other communication support case bot. At block 304, system 200 receives and stores a customer identification for the specific customer.

At decision block 306, system 200, for example implemented with the AI virtual support agent 204 determines whether a customer data file exists for the specific customer. When a customer data file does not exist, operations continue at block 312 following entry point B in FIG. 3B.

At block 308 in FIG. 3A, when a customer data file does not exist, system 200 obtains a customer statement of understanding for the current problem, and obtains customer responses to a set of questions that are based on the customer statement and the current problem. In an embodiment, the AI virtual support agent 204 of system 200 prompts the customer to explain the problem in detail, and describe the customer's experience with the product or service, and/or the specific problem, which are used to evaluate a competency or proficiency level of the specific customer for the current problem.

At block 310, system 200 calculates, using the AI virtual support agent 204, a current Customer Proficiency Rating for the new and returning customers that contact Support based on predefined data and analytics. In an embodiment, the AI virtual support agent 204 calculates a Customer Proficiency Rating based on customer Data and Analytics to identify a customer skill level for the current problem, where the customer Data and Analytics includes such as, customer experience with the product including a length of time (e.g., days, weeks, months, years) the customer has been using the product/service of the customer request for customer support. For example, the customer Data and Analytics further can include Frequency of earlier Support communication for the current product or service; Frequency of earlier Support communication for current problem or issue; Average length of time required to solve customer problems for the product or service in the past; Historical average of the Customer Proficiency Rating; and Most recent Customer Proficiency Rating. Operations continue at block 320 following entry point C in FIG. 3C.

In FIG. 3B, at block 312, the customer identification is routed to the AI virtual support agent 204 for support processing operations for the new specific customer. This initial assessment performed by the AI virtual support agent 204 can include multiple different forms of Customer Support interactions, including but not limited to online chatbot, virtual phone agent, virtual video-conferencing agent, virtual text messaging agent, virtual email agent, or other communication support bot. The AI virtual support agent 204 saves the initial assessment as a Customer Proficiency Rating in a database of the data storage 214, which includes a respective Customer Proficiency Rating for each customer of the product or service, and the Customer Proficiency Rating can be stored in the customer proficiency data set 210 and the support agent data set 212. The Customer Proficiency Rating provides a baseline for each specific customer that is used by an AI software algorithm of the AI virtual support agent 204 to determine an optimal human Support Agent (e.g., using the support agent data set 212) to communicate with the specific customer based on their competency or proficiency level.

For example, the Customer Proficiency Rating enables a selecting human Support Agent to speak with the customer (e.g., based on a Level of the support agent's expertise, such as Level 4 or 5 for a more highly skilled human Support Agent or possibly a less skilled human Support Agent, such as Level 1) who can explain required actions in terms the customer will easily understand. The baseline Customer Proficiency Rating stored in the customer proficiency data set 210 and data storage 214 can be used for the customer calls in the future. Use of a data history for each specific customer stored in the customer proficiency data set 210 and data storage 214 can save both the customer and the service provider time for problem resolution.

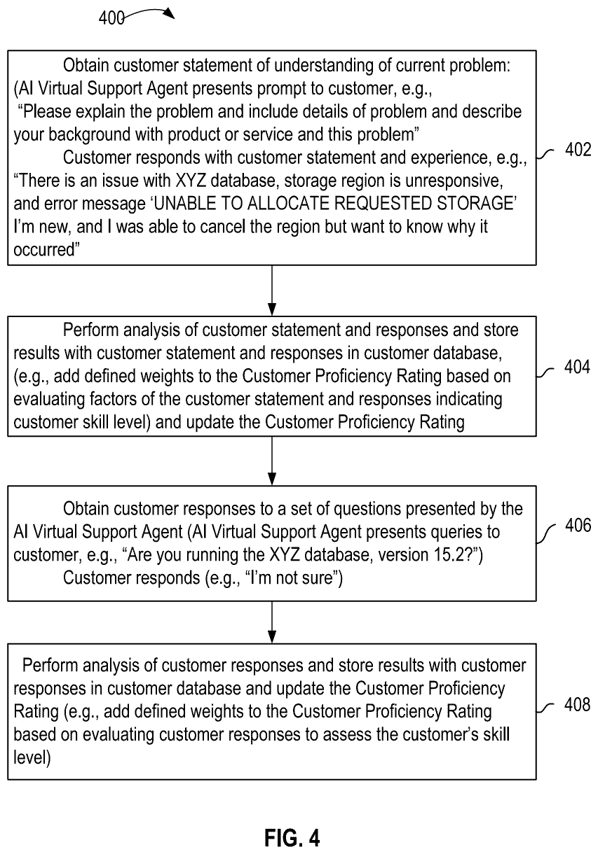

As shown at block 312 in FIG. 3B, the support processing operations of the AI virtual support agent 204 include 1. Creating a new customer data file based on the customer identification for the new specific customer; 2. Prompting the customer for explanation of the current problem and as customer for statement of understanding for the current problem, and ask the customer a set of predefined questions associated with the current problem to better identify the problem and determine the customer's understanding of the problem and the product. FIG. 4 illustrates example processing operations for customer assessment providing example details of questions presented at block 312, 2 by the AI virtual support agent 204.

Further at block 312, the support processing operations of the AI virtual support agent 204 include 3. Identifying and provide a proposed solution to the current problem and documentation related to the proposed solution, for example, probable solutions to problem are based on information of other known issues or errors seen by other users; 4. Answering customer questions and provide documentation to the customer, for example, questions are provided that are related to a customer question and documentation related to a customer question; and 5. Assign initial Customer Proficiency Rating based on the customer statement of the problem, and customer responses to the defined or standard set of questions that are asked by the AI virtual support agent 204 and used to assess or evaluate the customer skill level for the current problem. At decision block 314, system 200 determines whether the problem is resolved. For example, responsive to receiving a customer response that the problem is resolved, at block 316, system 200 ends communication and logs (i.e., stores) statistics for the support operations, and problem resolution. For example, the time and effort spent to solve the customer's problem, and an updated Customer Proficiency Rating from the support processing operations are stored. Otherwise, when determined the problem is not resolved, at block 318, system 200 logs statistics, such as the time and effort spent trying to solve the customer's problem, and the Customer Proficiency Rating is recorded based on the most recent correspondence or call. Operations continue, returning to block 310 following entry point A in FIG. 3A.

In FIG. 3C, at block 320 following entry point C, the AI virtual support agent 204 determines, based on the new Customer Proficiency Rating, to route the customer support calls, emails, chats, messaging, or Support cases to an optimal human Support Agent to assist the specific customer. The AI virtual support agent 204 can select an optimal human Support Agent using the calculated Customer Proficiency Rating, and based on the support agent data set 212. For example, to select an optimal human Support Agent at block 320, the AI virtual support agent 204 identifies 1. Level of support needed for identify a human Support Agent qualified to handle the difficulty of the stated problem (e.g., Level 1 through Level 5); 2. Specific support team or product area (e.g., a human Support Agent that resides in a team or area of the stated problem); and 3. Human Support Agent specialized in the precise area of concern of the customer problem. At decision block 322, system 200 determines whether the problem is resolved. When determined the problem is resolved, at block 324, system 200 ends communication and logs (i.e., stores) statistics for the support operations, problem resolution, and an updated Customer Proficiency Rating from the support processing operations, and a statement as provided by the human support agent. When determined the problem is not resolved, operations return to block 318 following entry point D in FIG. 3B where system 200 logs statistics and the operations continue as described above.

FIG. 4 illustrates example processing operations of an initial assessment of first- time customers of a method 400 to implement the Customer Proficiency Rating of one or more disclosed embodiments. At block 402, system 200 obtains a customer statement of understanding of the current problem. For example, as shown the AI virtual support agent 204 presents a prompt to the customer, such as “Please explain the problem and include details of the problem, and describe your background or experience with the product or service, and the specific problem”. As shown at block 402, the customer responds with a customer statement and experience, for example, “There is an issue with XYZ database, storage region is unresponsive and an error message ‘UNABLE TO ALLOCATE REQUESTED STORAGE’ I'm new and I was able to cancel the region but want to know why it happened.” At block 404, the AI virtual support agent 204 performs analysis of the customer statement and responses, and stores customer data including results analysis with the customer statement and responses. For example, AI virtual support agent 204 adds weights to the Customer Proficiency Rating, based on evaluating predefined factors of the customer statement and responses indicating the customer skill level, and updates the Customer Proficiency Rating at block 404. For example, AI virtual support agent 204 adds weights of +2 based on the customer description of the problem including the error message, adds weights of +1 based on the customer knowledge of product component of the problem, adds weights of −1 based on the customer experience with product or service of less than 1 year; and adds weights of +1 based on the customer knowing how to cancel a region, to provide a combined or net result to increment the Customer Proficiency Rating by=3.

At block 406, system 200 obtains customer responses to a set of questions presented by the AI virtual support agent 204 to the customer. For example, the AI virtual support agent 204 presents multiple queries to the customer, such as “Are you running the XYZ database, version 15.2?” and the customer responds “I′m not sure.” At block 406, system 200 performs analysis of the customer responses, and stores customer data including the results analysis, and stores the results with the customer responses in the customer data set 212 and/or the data storage 214. The AI virtual support agent 204 updates the Customer Proficiency Rating based on evaluating the customer responses to access the customer's skill level.

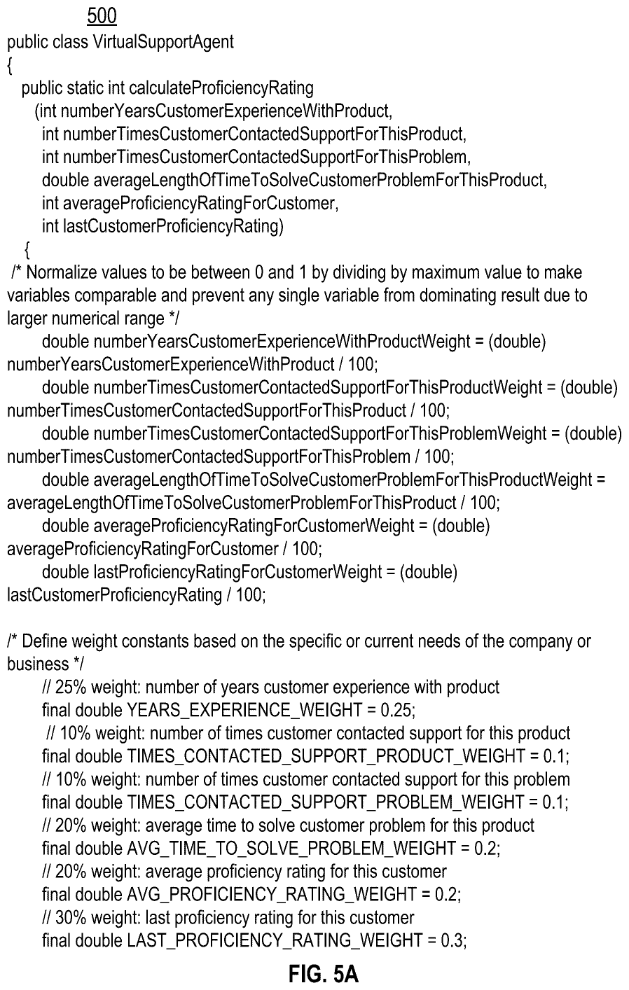

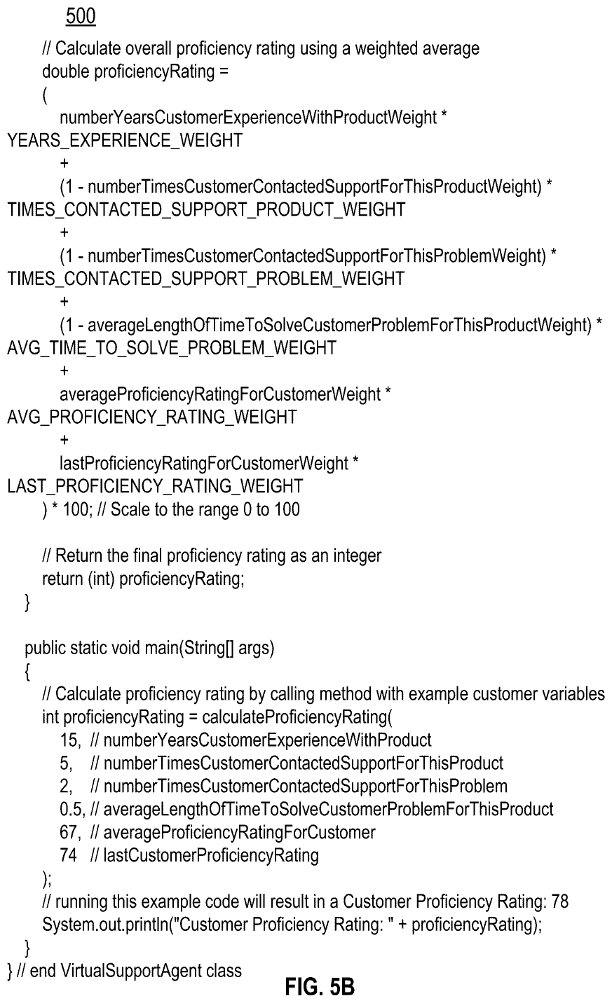

FIGS. 5A, and 5B together illustrate example pseudo code of a method 500 for performing a current assessment of new or returning customers contacting customer support of one or more disclosed embodiments. Method 500 provides illustrative pseudo code performed by the AI virtual support agent 204 to perform a current assessment of new or returning customers contacting Support for a particular product, service, or offering, as described above by system 200 with respect to FIG. 2. A Customer Proficiency Rating is assigned to the customer by the AI virtual support agent 204, such as illustrated and described with respect to FIGS. 3A, 3B, 3C, and 4.

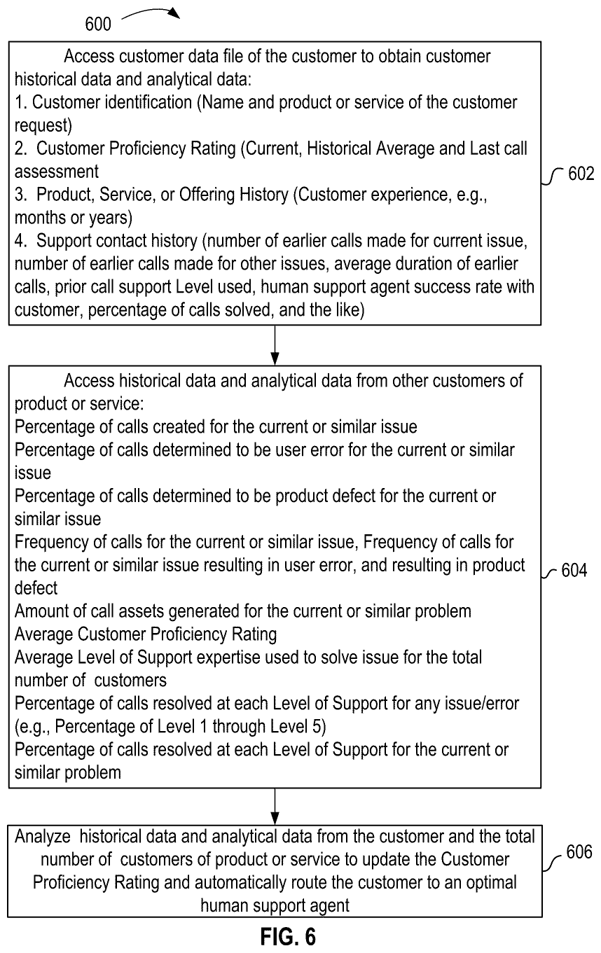

FIG. 6 illustrate example processing operations of Customer Proficiency Rating of a method 600 to identify and assign a human support agent of one or more disclosed embodiments. At block 602, the AI virtual support agent 204 (e.g., implementing a software algorithm) accesses a customer data file of a specific customer (e.g., stored in the data storage 214 and/or the customer proficiency data set 210 to obtain defined customer data including 1. Customer identification data (Name and product or service of the customer request); 2. Customer Proficiency Rating (Current, Historical Average, and last call assessment); 3. Product, Service, or Offering history (Customer experience e.g., number of months or years); 4. Support contact history (number of earlier calls made for current issue, number of earlier calls made for other issues, average duration of earlier calls, prior call support Level used; human support agent success rate with customer, percentage of calls solved at Level 2, percentage of calls solved at Level 3, and the like).

At block 604, the AI virtual support agent 204 accesses historical and analytic data for a total number of customers of the product or service, for example, to identify Percentage of calls created for current/similar issues, Percentage of calls determined to be user error for current or similar issues, Percentage of calls determined to be product defect for current or similar issues, Frequency of calls resulting in user error for current or similar issues, Frequency of calls resulting in product defect for current or similar issues. Amount of call assets generated for current or similar problem (e.g., total number of emails/chats available or total size of call logs in the database), Average Customer Proficiency Rating to solve current or similar issues, Average Level of Support expertise required to solve the current or similar issues, Percentage of calls resolved at each Level of Support for any issue or error, and Percentage of calls resolved at each Level of Support for the current or similar issues.

At block 606, the AI virtual support agent 204 analyzes historical and analytic data for the customer obtained at block 602 and for the total number of customers obtained at block 604 to select an optimal human support agent qualified to handle the problem (e.g., one of Level 1 through Level 5), in the specific support team or product area of the stated problem; and optionally specialized in the precise area of concern of the customer problem, such as described at block 320 in FIG. 3C.

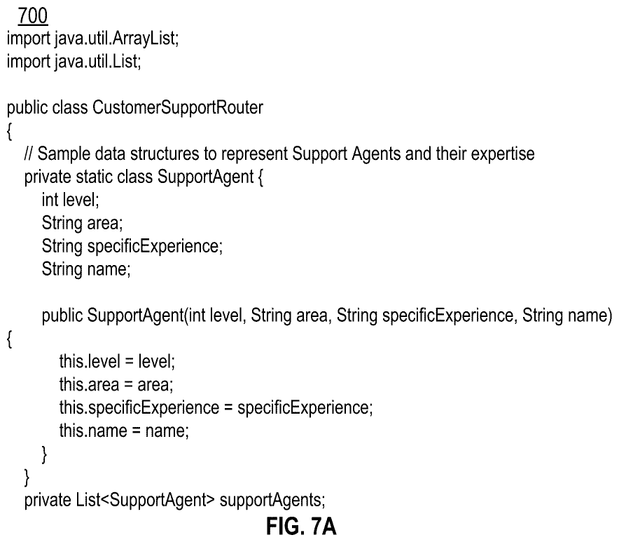

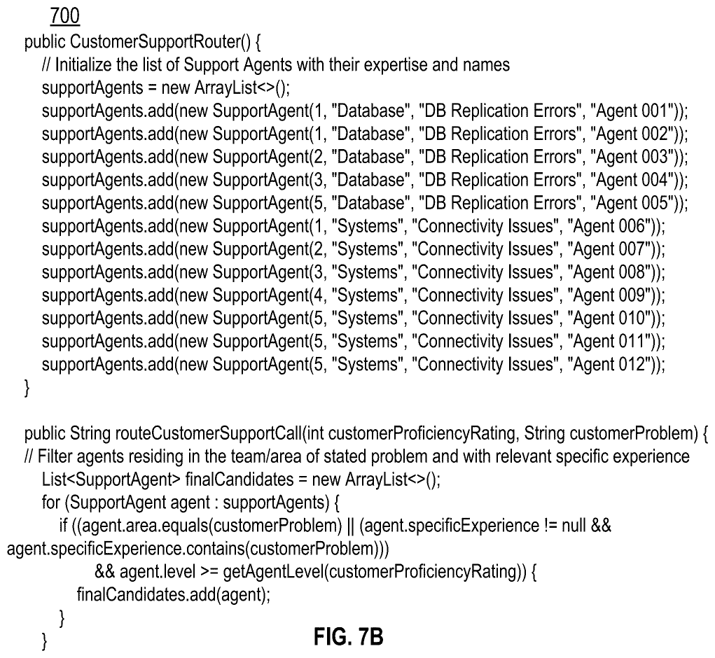

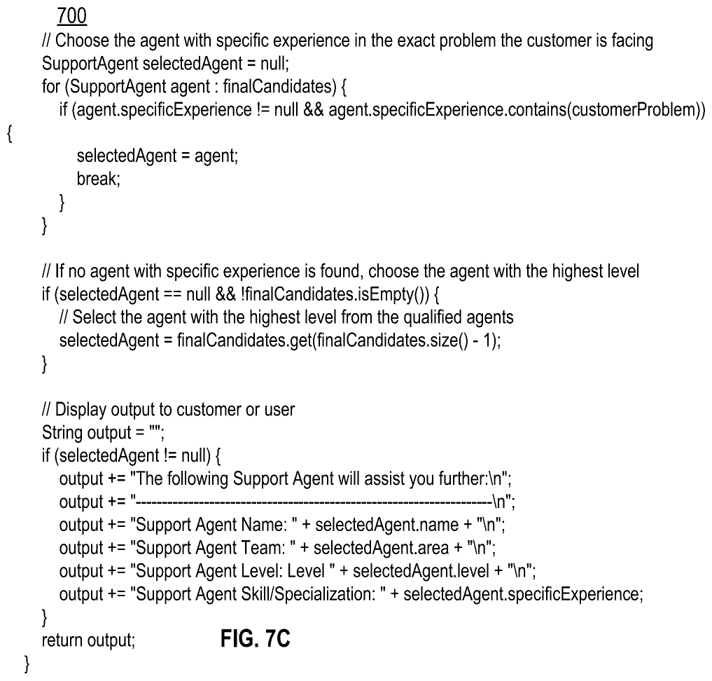

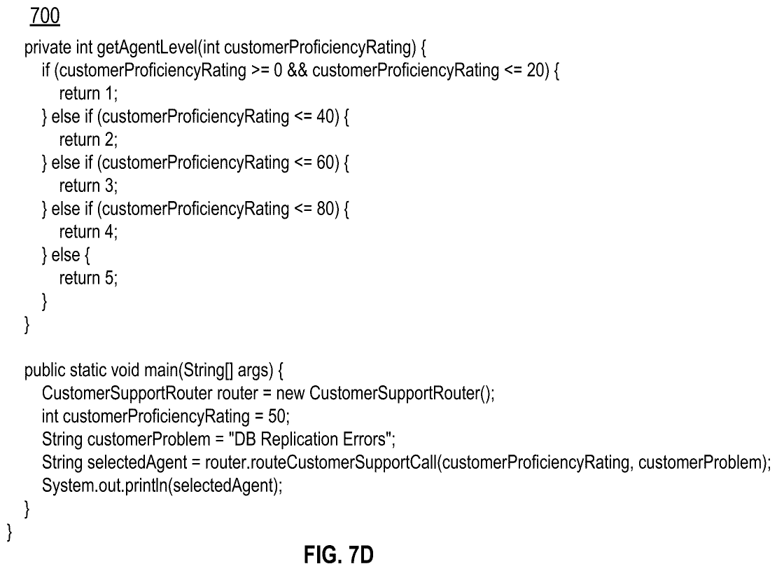

FIGS. 7A, 7B, 7C, and 7D together illustrate example pseudo code of a method 700 utilizing a calculated Customer Proficiency Rating to automatically route customer support requests (e.g., calls, emails, chats, messaging, or support cases) to an optimal Support Agent of one or more disclosed embodiments. Method 700 provides illustrative pseudo code performed by the AI virtual support agent 204 to select an optimal human support agent of disclosed embodiments, such as illustrated and described with respect to block 320 of FIG. 3C, and block 606 of FIG. 4.

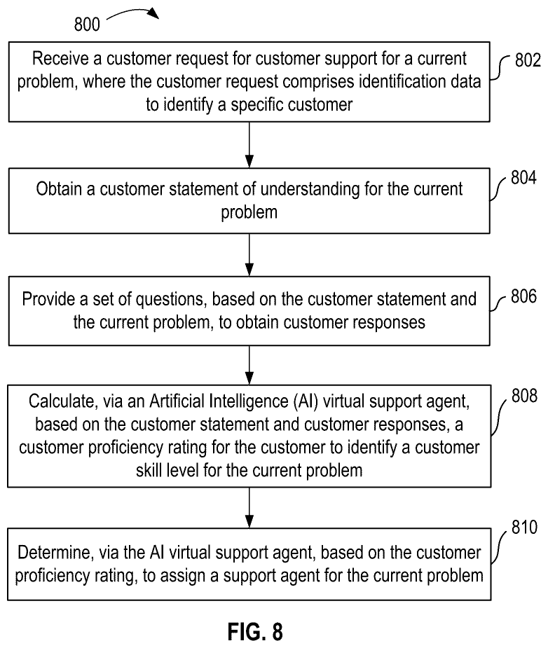

FIG. 8 illustrates features and customer support operations of a method 800 for implementing a Customer Proficiency Rating of a disclosed embodiment. At block 802, system 200 receives a customer request for customer support for a current problem; where the customer request comprises identification data to identify a specific customer. In an embodiment, the customer request is received from one of a virtual phone agent, a virtual video-conferencing agent, a virtual text messaging agent, a virtual email agent, support case bot, an interactive web form, or an online chatbot.

At block 804, system 200 obtains a customer statement of understanding for the current problem. In an embodiment, system 200 prompts the customer via the AI virtual support agent, to explain the problem and describe the customer's experience with the product or service, and/or the specific problem.

At block 806, system 200 provides a set of questions, based on the customer statement and the current problem, to obtain customer responses. In an embodiment, AI virtual support agent presents the set of questions to better understand the specific problem and identify the customer's understanding of a product or service of the customer support.

At block 808, system 200 calculates, via an Artificial Intelligence (AI) virtual support agent, based on the customer statement and the customer responses, a customer proficiency rating to identify a customer skill level for the current problem. In an embodiment, the AI virtual support agent 204 calculates the customer proficiency rating based on at least one of historical data and analytical data of the specific customer. In an embodiment, the AI virtual support agent 204 calculates the customer proficiency rating based on at least one of historical data and analytical data of other customers of the product or service of the customer support.

At block 810, system 200 determines, via the AI virtual support agent, based on the customer proficiency rating, to assign a support agent for the current problem. In an embodiment, the AI virtual support agent 204 updates the customer proficiency rating using customer data and analytical data for the customer. In an embodiment, the AI virtual support agent 204 updates the customer proficiency rating using customer data and analytical data for other customers of the product or service of the customer support. In an embodiment, the AI virtual support agent 204 identifies, based on the current problem and the product or service area, one or more of a product or service area of the support agent, an expertise level of the support agent, or experience of the support agent for the current problem.

While the foregoing is directed to embodiments of the present invention, other and further embodiments of the invention may be devised without departing from the basic scope thereof, and the scope thereof is determined by the claims that follow.

What is claimed is:

1. A computer-implemented method comprising:
receiving a customer request for customer support for a current problem of a product or service area, wherein the customer request comprises customer identification data to identify a specific customer;
obtaining a customer statement of understanding for the current problem;
providing a set of questions, based on the customer statement and the current problem, to obtain customer responses;
calculating, via an Artificial Intelligence (AI) virtual support agent, based on the customer statement and the customer responses, a customer proficiency rating for the customer to identify a customer skill level for the current problem; and
determining, via the AI virtual support agent, based on the customer proficiency rating, to assign a support agent for the current problem.

2. The method of claim 1, wherein receiving the customer request for customer support further comprises receiving the customer request from one of a virtual phone agent, a virtual video-conferencing agent, a virtual text messaging agent, a virtual email agent, a support case bot, an interactive web form, or an online chatbot.

3. The method of claim 1, wherein receiving the customer request for customer support further comprises checking, via the AI virtual support agent, based on the customer identification data, for one or more of historical data and analytical data for the customer, a historical average customer proficiency rating, or a most recent customer proficiency rating for the specific customer.

4. The method of claim 3, further comprises updating the customer proficiency rating based on at least one of the historical data and the analytical data for the customer, the historical average customer proficiency rating, or the most recent customer proficiency rating for the customer.

5. The method of claim 1, wherein providing the set of questions further comprises identifying, via the AI virtual support agent, based on the customer responses, a proposed solution for the current problem, and providing the proposed solution to the customer.

6. The method of claim 5, further comprises providing documentation to the customer that is related to the proposed solution, and answering customer questions.

7. The method of claim 1, wherein providing the set of questions further comprises receiving, via the AI virtual support agent, a customer question and answering the customer question, wherein answering the customer question further comprises providing at least one of questions related to the customer question, or documentation related to the customer question.

8. The method of claim 1, wherein providing the set of questions further comprises based on receiving a customer response that the current problem is resolved; via the AI virtual support agent, ending the customer support; and storing statistics related to the customer support, wherein the statistics comprise an updated customer proficiency rating for the customer.

9. The method of claim 1, wherein determining, via the AI virtual support agent, based on the customer proficiency rating, to assign the support agent for the current problem further comprises identifying, based on the current problem and the product or service area, one or more of a product or service area of the support agent, an expertise level of the support agent, or experience of the support agent for the current problem.

10. The method of claim 1, wherein providing the set of questions further comprises providing, via the AI virtual support agent, a plurality of interactive customer requests, based on one or more customer responses to the set of questions, ending the customer support based on resolving the current problem; and updating the customer proficiency rating based on historical data and analytical data of the customer and other customers of the product or service area.

11. A system, one or more computer processors; and a memory containing a program which when executed by the one or more computer processors performs an operation, the operation comprising:
receiving a customer request for customer support for a current problem of a product or service area; wherein the customer request comprises identification data to identify a specific customer;
obtaining a customer statement of understanding for the current problem;
providing a set of questions, based on the customer statement and the current problem, to obtain customer responses;
calculating, via an Artificial Intelligence (AI) virtual support agent, based on the customer statement and the customer responses, a customer proficiency rating for the customer to identify a customer skill level for the current problem; and
determining, via the AI virtual support agent, based on the customer proficiency rating, to assign a support agent for the current problem.

12. The system of claim 11, wherein receiving the customer request for customer support further comprises checking, based on the customer identification data, for one or more of historical data and analytical data for the customer, a historical average customer proficiency rating, or a most recent customer proficiency rating for the specific customer.

13. The system of claim 12, further comprises updating the customer proficiency rating based on at least one of the historical data and the analytical data for the specific customer, the historical average customer proficiency rating, or the most recent customer proficiency rating for the specific customer.

14. The system of claim 11, wherein providing the set of questions further comprises identifying, via the AI virtual support agent, based on the customer responses, a proposed solution for the current problem, and providing the proposed solution to the specific customer.

15. The system of claim 11, wherein providing the set of questions further comprises responsive to receiving a customer response that the current problem is resolved; via the AI virtual support agent, ending the customer support; and storing statistics related to the customer support, wherein the statistics comprise an updated customer proficiency rating for the specific customer.

16. A computer program product comprising a computer-readable storage medium having computer-readable program code embodied therewith, the computer-readable program code executable by one or more computer processors to perform an operation comprising:
receiving a customer request for customer support for a current problem of a product or service area; where the customer request comprises identification data to identify a specific customer;
obtaining a customer statement of understanding for the current problem;
providing a set of questions, based on the customer statement and the current problem, to obtain customer responses;
calculating, via an Artificial Intelligence (AI) virtual support agent, based on the customer statement and the customer responses, a customer proficiency rating for the specific customer to identify a customer skill level for the current problem; and
determining, via the AI virtual support agent, based on the customer proficiency rating, to assign a support agent for the current problem.

17. The computer program product of claim 16, wherein receiving the customer request for customer support further comprises checking, based on the customer identification data, for one or more of historical data and analytical data for the customer, a historical average customer proficiency rating, or a most recent customer proficiency rating for the specific customer.

18. The computer program product of claim 17, further comprises updating the customer proficiency rating based on at least one of the historical data and the analytical data for the specific customer, the historical average customer proficiency rating, or the most recent customer proficiency rating for the specific customer.

19. The computer program product of claim 16, wherein providing the set of questions further comprises identifying, via the AI virtual support agent, based on the customer responses, a proposed solution for the current problem, and providing the proposed solution to the specific customer.

20. The computer program product of claim 16, wherein providing the set of questions further comprises responsive to receiving a customer response that the current problem is resolved; ending the customer support; and storing statistics related to the customer support, wherein the statistics comprise an updated customer proficiency rating for the specific customer.
